(19) United States
(12) Patent Application Publication
(10) Pub. No.: US 2009/0018813 A1
(43) Pub. Date: Jan. 15, 2009

(54) USING QUANTITATIVE MODELS FOR PREDICTIVE SLA MANAGEMENT

(75) Inventors: Ravi Kothari, New Delhi (IN); Bikram Sengupta, New Delhi (IN)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 12/059,090

(22) Filed: Mar. 31, 2008

Related U.S. Application Data
(63) Continuation of application No. 11/776,719, filed on Jul. 12, 2007.

(51) Int. Cl. G06F 9/45

(52) U.S. Cl. 703/22

(57) ABSTRACT

A method of using quantitative models for predictive service level agreement management builds quantitative models, executes the models to produce observations, and determines whether the observations conform to service level agreements. If the observations do not conform to the service level agreements, the method determines the service level agreements that are violated by the observations. Then, the method calculates analytic measures for use in the service level agreements based on the observations and the violations.

### CROSS-REFERENCE TO RELATED APPLICATIONS

This application is a continuation of U.S. application Ser. No. 11/776,719 filed Jul. 12, 2007, the complete disclosure of which, in its entirety, is herein incorporated by reference.

### BACKGROUND AND SUMMARY

The embodiments of the invention generally relate to service level agreement management and more particularly to using quantitative models for predictive service level agreement management.

As the IT industry witnesses a shift towards service-oriented business models, the negotiation and management of Service Level Agreements (SLAs) between the customer and the service provider become increasingly important. SLAs are generally authored on those aspects of system behavior that are directly visible to the end-user; typically, these aspects include the availability and response-time/latency of some of the critical business processes. The business processes however, run on complex and heterogeneous IT infrastructure, and it is the behavior of this IT infrastructure that ultimately determines the performance of the business processes and the end-user experience.

If a business function is unavailable it may be because of a variety of reasons e.g. an application server has crashed, a network link is broken, or a database server process may have gone down. But, the impact of IT on business is often not well-understood, leading to troubled SLAs. Troubled projects are impacted by scope, estimation and negotiation. Therefore, there is a great need to sign the right service level agreements. Conventional SLA reports, which associate IT data with business data, are reactive in nature. However, SLA misses carry steep penalties and there is a need to make SLA authoring and management predictive.

Questions that must be answered include the following. What is a realistic commitment to make in a SLA? What infrastructure problems can lead to an SLA violation? How frequently should embodiments herein monitor the infrastructure? In response, the embodiments herein present a model-based method for quantitative evaluation of SLAs. In practice, a huge amount of monitoring data is collected in enterprise IT environments, either manually or through some management solution, and SLA reports are prepared based on the collected data. While this approach does associate IT data with business data in some sense, as mentioned above, it is essentially reactive in nature, and its main purpose is to derive consequential activities in terms of rights and obligations in case of violations. Given that SLAs are of critical importance to both the customer (whose business depends on SLAs being met) and the service provider (who has to bear steep penalties in case of an SLA miss), there is a need to make SLA authoring and management predictive in nature, and the impact of individual IT components on a SLA needs to be understood in advance so that they can be appropriately monitored and managed. This is achieved herein through quantitative modeling of IT components, executing these models to generate observations and relating the observations to SLA compliance.

### BRIEF DESCRIPTION OF THE DRAWINGS

The embodiments of the invention will be better understood from the following detailed description with reference to the drawings, in which:

FIG. 1 is a flow diagram illustrating a method embodiment herein;

FIG. 2 is a schematic diagram illustrating models according to embodiments herein;

FIG. 3 is a schematic diagram illustrating models according to embodiments herein;

FIG. 4 is a schematic diagram illustrating models according to embodiments herein;

FIG. 5 is a schematic diagram illustrating directional interconnection of functions of instantiated models according to embodiments herein; and

FIG. 6 is a chart illustrating results of model execution according to embodiments herein.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

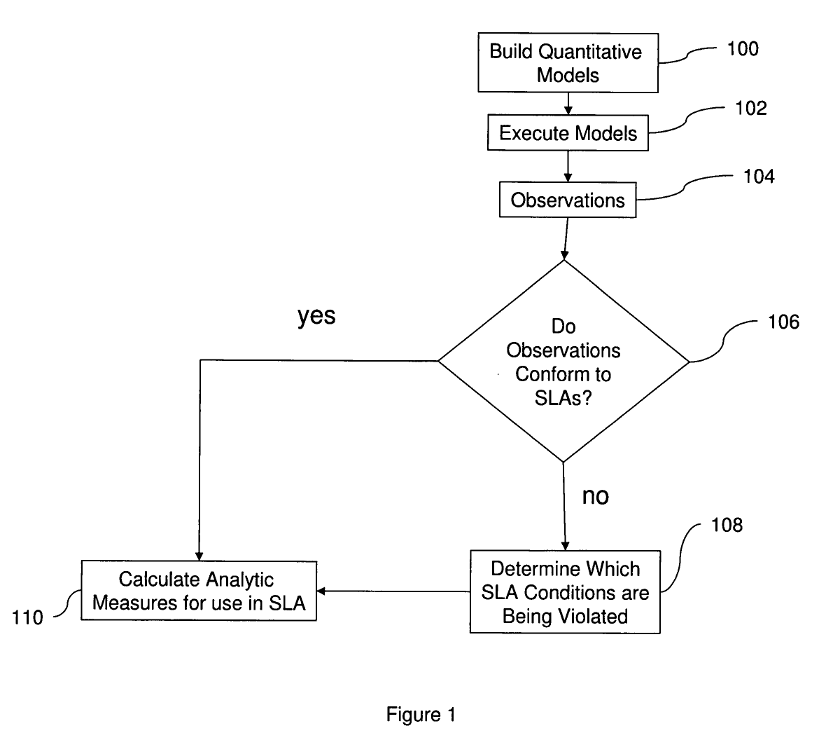

As shown in Flowchart form in FIG. 1, in one embodiment herein, quantitative models that represent the behavior of the different IT components are built (100). Next, these models are executed (102) to generate observations (104) on the overall systems behavior. SLA computation methodologies can be run on the generated observation sequences to determine if they conform to the SLAs (106), and if not, then under what conditions SLAs are being violated (108). These conditions may then be used as a basis for useful analytic measures that can be included within the SLA (110) like coming up with realistic SLA guarantees, doing variable-rate “on-demand” monitoring of IT infrastructure, and identifying SLOs that may be composed. These steps are explained in greater detail below.

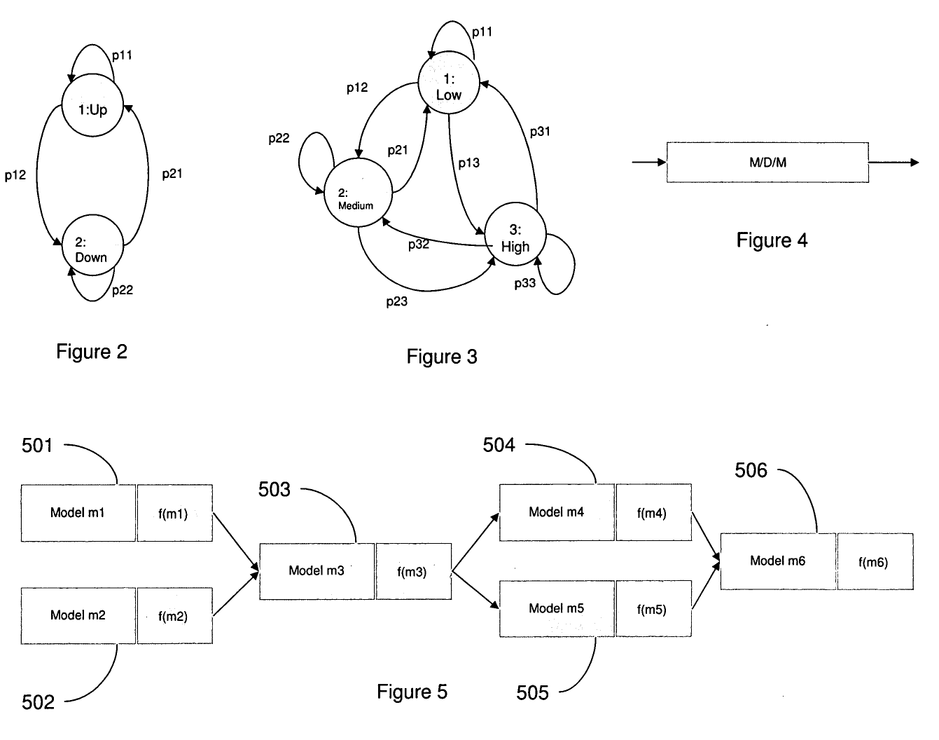

The metric of interest for any component is modeled using quantitative and executable models (100). Examples of such models include rules, queues, Hidden-Markov models (HMMs), Petri-nets etc. (see U.S. Patent Publication 2006/0064037, incorporated herein by reference, for a complete discussion of such models). Each entity may have multiple models associated with it (corresponding to different metrics). Models may be empirically constructed or specified by a domain expert. Example HMM models of availability and latency are shown in FIGS. 2-4.

To model availability, embodiments herein can use a 2-state model with the states 1 and 2 being “Up” and “Down” (see FIG. 2) along with associated transition probabilities p11; p12; p21; p22. For properties like latency, embodiments herein can use a n-state model, each state representing a different expected latency value or range and associated transition probabilities. This is shown in FIG. 3, where there are 3 states (1: Low, 2: Medium, 3: High) along with associated transition probabilities p11; p12; p13; p22; p23; p21; p33; p32; p31. For metrics like throughput, a queue model (M/D/M) may be more appropriate, as shown in FIG. 4. Once these models are in place, embodiments herein define a system as an inter-connection of these models, and the system may then be simulated by running the model forward during the execution step in item 102.

As shown in FIG. 5, an SLA may be seen as a directional interconnection (the arrows in FIG. 5) of functions of instantiated models 501-505. For example, a function of an instantiated model is (Q<30) where Q is a parameter associated with a model instance. Another example may be (E[x(t)]>20).

In the model execution and evaluation, the behavior of IT components may not be independent. Infeasible transitions may be avoided by adding constraints to the execution engine. Execution of models allows embodiments herein to generate the observations 104 based on which SLAs may be evaluated. Some simple HMM-based examples are considered next.

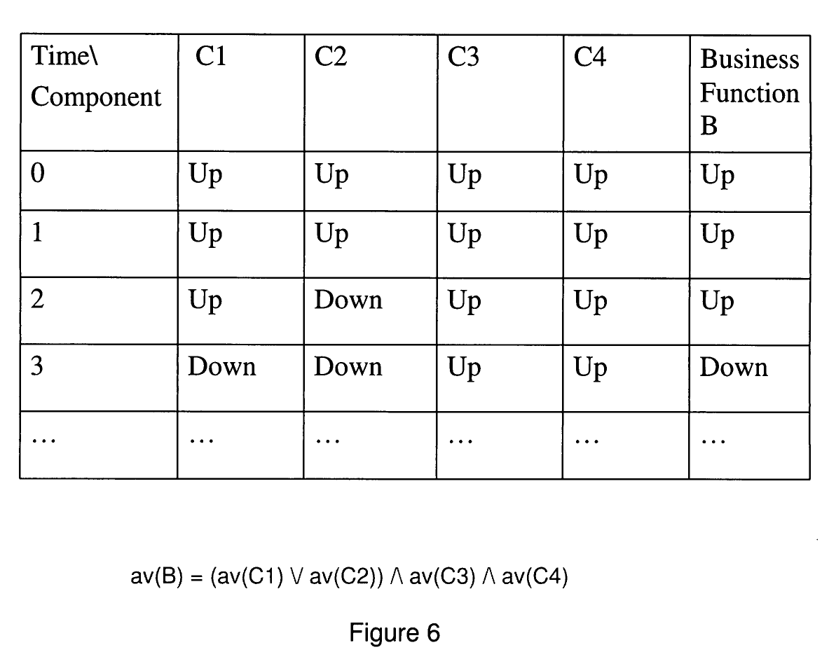

As shown in FIG. 6, suppose the availability of a business function B depends on the availability of 4 application components C1, C2, C3 and C4. Once embodiments herein have availability models of these 4 components, embodiments herein can execute them concurrently and get a time-sequence of observations as shown in FIG. 6.

Based on these observations, embodiments herein can determine the availability of B e.g. assume B is available if at least one of C1 or C2 is available, and if C3 as well as C4 are available (i.e. av(B)=(av(C1) [symbol] av(C2)) [symbol] av(C3) [symbol] av(C4)). Then the availability of B is shown in the rightmost column in FIG. 6. From these values, embodiments herein can then determine a variety of statistics e.g. maximum continuous down-time of B, number of times B went down etc., as per the SLA requirements. Similarly, suppose the latency of a business function B depends on the latency of 4 application components C1, C2, C3 and C4; C1 and C2 execute in parallel, and after both finish, C3 and C4 execute sequentially. Then embodiments herein can define latency(B)=max(latency(C1),latency(C2))+latency(C3)+latency(C4). Once embodiments herein execute the latency models of C1, C2, C3 and C4, embodiments herein can get estimated latencies of B from the observed component latencies and embodiments herein can compute different statistics e.g. what is the average latency of B, what is the maximum latency etc., which may have to be reported in an SLA.

The embodiments herein are useful with simulation environments that can support standard mathematical operators and functions as used above, to express the attributes of higher-level entities (e.g. business functions) in terms of the attributes of lower-level entities (e.g., servers, applications etc.). Frequently used statistics like average, maximum etc. may also be built-in. In addition to these however, users may want to use their own computation methodologies. The simulation environment will allow such external modules to “plug-in” and operate on the raw simulation data.

Simulation of models and evaluation of SLA compliance on the simulation data in item 106 forms the basis for performing a number of useful analytics. This disclosure considers some of these below.

First, with embodiments herein a simulation environment may be used interactively by the users to edit behavioral models, execute them, and view the impact on SLAs in real-time. This will help them come up with practical SLA commitments. Occasional violation of non-critical SLAs (that carry relatively low penalty) may be acceptable and users may choose not to demand exacting performance guarantees from the IT components for these SLAs. On the other hand, in case of noncompliance of critical SLAs, users would want to refine the behavioral models to improve the chances of SLAs being met. If available historical evidence suggests that such improvements cannot be easily achieved using the existing IT infrastructure, then infrastructure transformations may be required.

Simulation data may also be mined to discover patterns of behavior that lead to SLA violations. Such patterns may include sequences of events (“e.g. servers S1 and S2 going down within 5 minutes of each other”), leading to a “bad” state (i.e. SLA violation). This knowledge may be used during the operational phase to do more intelligent monitoring “on-demand”. For example, if a monitoring solution is being used, then it may be possible to configure it to do more rigorous monitoring when such conditions (bad states) are being approached. Thus, monitoring may be made variable-rate and context-sensitive. Again, the knowledge may be used for the composition of Service Level Objectives (SLOs) e.g. while there may be separate SLOs to track the availability of S1 and S2 in the example above, the pattern indicates that it may be useful to be able to track the occurrence of unavailability events from S1 and S2 together within a time-window. Note that even if a monitoring solution is not being used, such knowledge may be used to train human agents manually monitoring the system about patterns of behavior they should be especially careful about, so that problem determination and resolution is proactive.

With embodiments herein, the simulation and analysis environment described above is useful across multiple business phases. During knowledge acquisition, embodiments herein may be used to build stochastic models of IT components based on historical data, if available. During SLA authoring, embodiments herein can simulate models of IT components to observe their impact on SLAs. This will help negotiate realistic SLA commitments and in case of mismatch between what stochastic models predict and what customers need, embodiments herein will also indicate areas where transformation is needed. During the operational phase, the stochastic models may be used to determine reasonable threshold values, using which the behavior of IT components may be monitored. Simulation of the models will also help identify conditions that can lead to SLA violations and these conditions may call for more rigorous monitoring; in other words, monitoring may be made variable-rate and “context-sensitive”. Proactive SLA management in this way leads to a fewer number of SLA violations, which leads to substantial monetary savings for both the consumer (better business performance) and the service provider (less penalties).

Some benefits of practical SLA commitments produced by these embodiments are that users may edit models on-the-fly and view impact on business functions to arrive at reasonable service levels. Critical SLAs may demand more exacting IT performance and may suggest areas where transformation is needed. Data mining techniques on simulation data may be used to discover patterns of behavior that may lead to a “bad” state (e.g. a sequence of unavailability events within a time-window of n minutes) and this may be used as a basis for variable-rate monitoring “on-demand”. Further, the embodiments herein can perform more rigorous monitoring as such patterns are detected and a “bad” state is being approached. Human agents may be trained and monitoring solutions may be configured e.g. through Service Level Objective (SLO) composition.

In the potential business impact during knowledge acquisition, the embodiments herein may be used to build quantitative models of IT components based on historical data, if available. During SLA re-negotiation, historical data is made readily available by embodiments herein.

Thus, as shown above, predictive SLA management leads to a fewer number of SLA violations, which can lead to substantial monetary savings for both the consumer (better business performance) and the service provider (less penalties). The embodiments herein produce a simulation-and-analysis environment for predictive management of SLAs, which supports quantitative modeling of the behavior of IT components. Models may be inferred from historical data and inter-model dependencies may be encoded as constraints.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method of using quantitative models for predictive service level agreement management comprising:
building quantitative models;
executing selected models of said models to produce observations;
determining whether said observations conform to service level agreements;
if said observations do not conform to said service level agreements, determining violations, wherein said violations comprise ones of said service level agreements that are violated by said observations; and
based on said observations and said violations, calculating analytic measures that provide guidance for determining service level agreement parameters that are achievable for use in said service level agreements.

2. The method according to claim 1, all the limitations of which are incorporated herein by reference, wherein an interconnection of said models comprises a system and wherein said executing comprises running said system.

3. The method according to claim 1, all the limitations of which are incorporated herein by reference, wherein a service level agreement comprises a directional interconnection of functions of said models.

4. A method of using quantitative models for predictive service level agreement management comprising:
building quantitative models;
executing selected models of said models to produce observations;
determining whether said observations conform to service level agreements;
if said observations do not conform to said service level agreements, determining violations, wherein said violations comprise ones of said service level agreements that are violated by said observations; and
based on said observations and said violations, determining patterns of behavior that lead to said violations and using said violations as basis for variable-rate context-sensitive monitoring of infrastructure.

5. The method according to claim 4, all the limitations of which are incorporated herein by reference, wherein an interconnection of said models comprises a system and wherein said executing comprises running said system.

6. The method according to claim 4, all the limitations of which are incorporated herein by reference, wherein a service level agreement comprises a directional interconnection of functions of said models.
